(19) United States
(12) Patent Application Publication
(10) Pub. No.: US 2024/0213597 A1
(43) Pub. Date: Jun. 27, 2024

(54) INSERT MOLD FOR A BATTERY TERMINAL

(71) Applicant: Rivian IP Holdings, LLC, Plymouth, MI (US)

(72) Inventors: Yunki Baik, San Jose, CA (US); Ki Woon Kim, Milpitas, CA (US); Sun Ung Kim, Pleasanton, CA (US); Jinyong Kim, San Jose, CA (US)

(21) Appl. No.: 18/146,743

(22) Filed: Dec. 27, 2022

(51) Int. Cl. H01M 50/172; H01M 4/78; H01M 50/171; H01M 50/195; H01M 50/55

(52) U.S. Cl. CPC H01M 50/172; H01M 4/78; H01M 50/171; H01M 50/195; H01M 50/55; H01M 2220/20

(57) ABSTRACT

The present disclosure relates to a battery cell. The battery cell can include an enclosure member that can enclose an electrode. The battery cell can include a mold that couples with a portion of the enclosure member. The mold can surround a portion of a terminal. The terminal can form a conductive pathway with the electrode.

### INTRODUCTION

Electric vehicles can include various electrical components that provide power to the vehicle. The electrical components can be electrically coupled with vehicle components to power the vehicle.

### SUMMARY

A battery cell can include one or more terminals coupled with a housing of the battery cell. The battery cell can include at least one mold (e.g., an insert mold, a terminal mode). The mold can include molded plastic resin mixed with one or more additional materials (e.g., conductive carbon black, carbon nano tube, carbon glass fiber, or another material). The mold can at least partially surround (e.g., enclose) a terminal. The terminal can include or can couple with a current collector. The current collector can extend from a portion of the terminal to electrically couple with a tab of an electrode (e.g., a plurality of foils coupled together). The tab or the current collector can flex or bend such that the tab or the current collector can include at least one bend to form a serpentine shape (e.g., a “Z” shape, an “S” shape) or another shape (e.g., a “U” shape). The mold can include a gasket integrated into the mold (e.g., embedded within the mold).

At least one aspect is directed to a battery cell. The battery cell can include an enclosure member that can enclose an electrode. The battery cell can include a mold that couples with a portion of the enclosure member. The mold can surround a portion of a terminal. The terminal can form a conductive pathway with the electrode.

At least one aspect is directed to a method. The method can include providing a battery cell having an enclosure member enclosing an electrode. The method can include coupling a mold with a portion of the enclosure member. The method can include enclosing, by the mold, a portion of a terminal. The method can include forming a conductive pathway between the terminal and the electrode.

At least one aspect is directed to an electric vehicle. The electric vehicle can include a battery cell. The battery cell can include an enclosure member that can enclose an electrode. The battery cell can include a mold that couples with a portion of the enclosure member. The mold can surround a portion of a terminal. The terminal can form a conductive pathway with the electrode.

At least one aspect is directed to a battery. The battery can include a battery cell. The battery cell can include an enclosure member that can enclose an electrode. The battery cell can include a mold that couples with a portion of the enclosure member. The mold can surround a portion of a terminal. The terminal can form a conductive pathway with the electrode.

At least one aspect is directed to a method. The method can include providing a battery cell. The battery cell can include an enclosure member that can enclose an electrode. The battery cell can include a mold that couples with a portion of the enclosure member. The mold can surround a portion of a terminal. The terminal can form a conductive pathway with the electrode.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example side view of an electric vehicle, in accordance with implementations.

FIG. 2A depicts an example perspective view of a battery pack, in accordance with implementations.

FIG. 2B depicts an example perspective view of a battery module, in accordance with implementations.

FIG. 2C depicts an example perspective view of a battery cell, in accordance with implementations.

FIG. 2D depicts an example perspective view of a battery cell, in accordance with implementations.

FIG. 2E depicts an example perspective view of a battery cell, in accordance with implementations.

FIG. 2F depicts an example top view of a battery pack, in accordance with implementations.

FIG. 2G depicts an example top view of a battery pack, in accordance with implementations.

FIG. 3A depicts an example side view of a portion of a battery cell, in accordance with implementations.

FIG. 3B depicts an example perspective view of a portion of a battery cell, in accordance with implementations.

FIG. 4 depicts an example top cross-sectional of a portion a battery cell, in accordance with implementations.

FIG. 5 depicts an example top cross-sectional of a portion a battery cell system, in accordance with implementations.

FIG. 6 depicts an example top cross-sectional of a portion a battery cell system, in accordance with implementations

FIG. 7 depicts an example top cross-sectional of a portion a battery cell system, in accordance with implementations.

FIG. 8 depicts an example top cross-sectional of a portion of a battery cell, in accordance with implementations.

FIG. 9 depicts an example illustration of a process, in accordance with implementations.

FIG. 10 depicts an example illustration of a process, in accordance with implementations.

### DETAILED DESCRIPTION

Following below are more detailed descriptions of various concepts related to, and implementations of, methods, apparatuses, and systems of coupling a terminal with a battery cell by a mold (e.g., an insert or terminal mold). The various concepts introduced above and discussed in greater detail below may be implemented in any of numerous ways.

An insert mold can refer to a technology which can be a variation from conventional injection molding. Injection molding can have a cavity in which molten resin is filled and formed. In the insert mold approach, there can be a die for the existing parts, and the gaps between parts can be filled with molten resin. Insert can refer to pre-arrangement of existing parts before injection molding.

This disclosure is generally directed to an insert-molded terminal of a battery cell. For example, the battery cell can include a housing having a first side, a second opposing side, a first enclosure member, and a second opposing enclosure member. The battery cell can include at least one terminal coupled with the first enclosure member. The battery cell can include at least one second terminal coupled with the second enclosure member such that the battery cell includes at least two opposing terminals. The battery cell can include at least one mold (e.g., an insert mold, terminal mold). The mold can include molded plastic resin mixed with one or more additional materials (e.g., conductive carbon black, carbon nano tube, carbon glass fiber, or another material). The mold can include one or more flanges (e.g., extensions, protrusions) that facilitate coupling the mold with an enclosure member. For example, the mold can couple with an enclosure member such that the mold includes a flange that extends at least partially along a first side and an opposing second side of an enclosure member. The mold can at least partially surround (e.g., enclose) a terminal. The terminal can include or can couple with a current collector. The current collector can extend from a portion of the terminal to electrically couple with a tab of an electrode (e.g., a plurality of foils coupled together). The tab or the current collector can flex or bend such that the tab or the current collector can include at least one bend to form a serpentine shape (e.g., a “Z” shape, an “S” shape) or another shape (e.g., a “U” shape). The mold can include a gasket integrated into the mold (e.g., embedded within the mold). For example, the mold can eliminate or reduce the need for one or more gaskets, rivets terminals, or insulators.

The disclosed solutions have a technical advantage of increasing energy density of a battery cell and reducing or eliminating the need for binding certain battery cell components. For example, conventional battery cell techniques may require a rivet terminal with binding between the rivet terminal, a portion of the battery cell housing, and a current collector. The disclosed solutions include an insert mold (terminal mold) that couples the terminal with a portion of the battery cell housing and secures the terminal with the current collector and with the battery cell housing such that binding is no longer necessary. Furthermore, a connection between the current collector and a portion of an electrode of the battery cell (e.g., such as a tab) can flex and compress such that more space is saved within the battery cell housing for active material of the electrode, which can increase the overall energy density of the cell in comparison with conventional technologies.

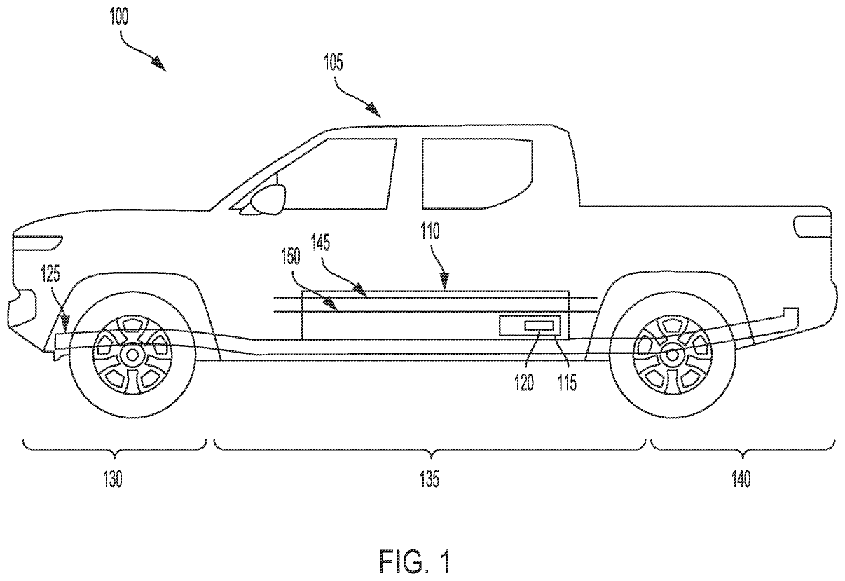

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

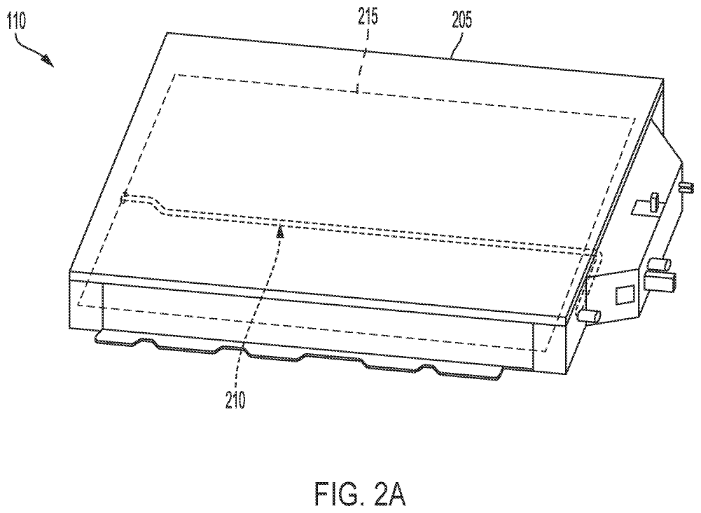

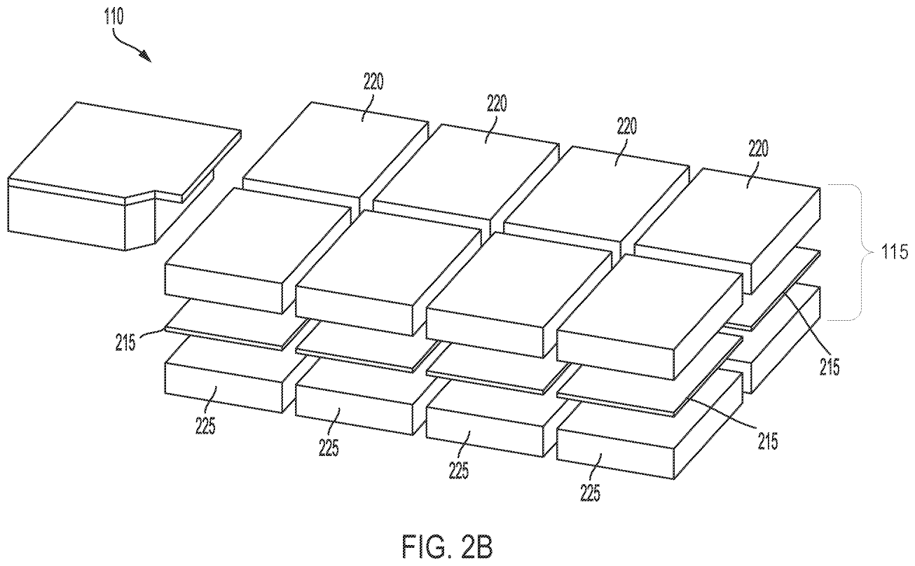

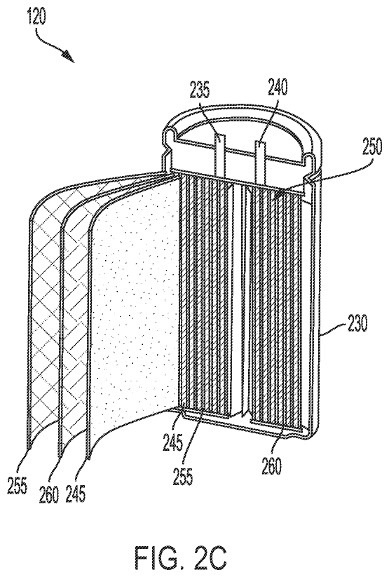

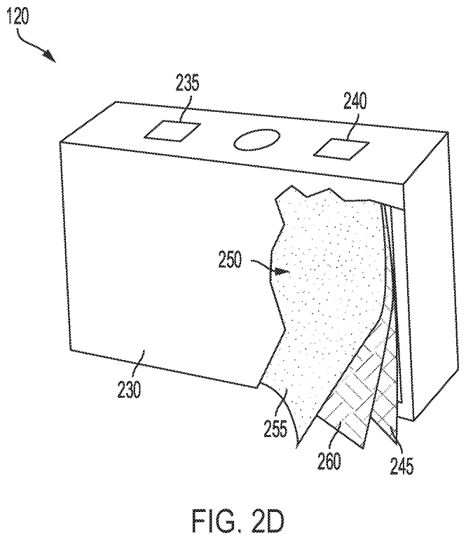

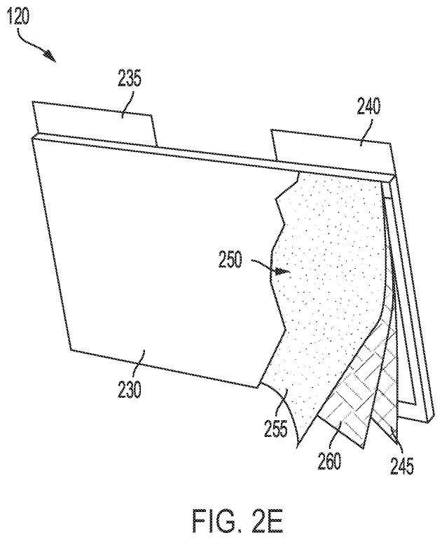

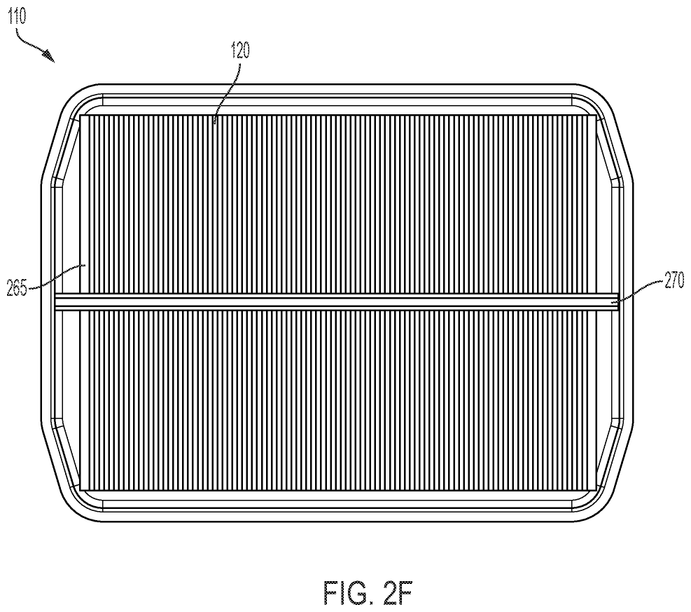

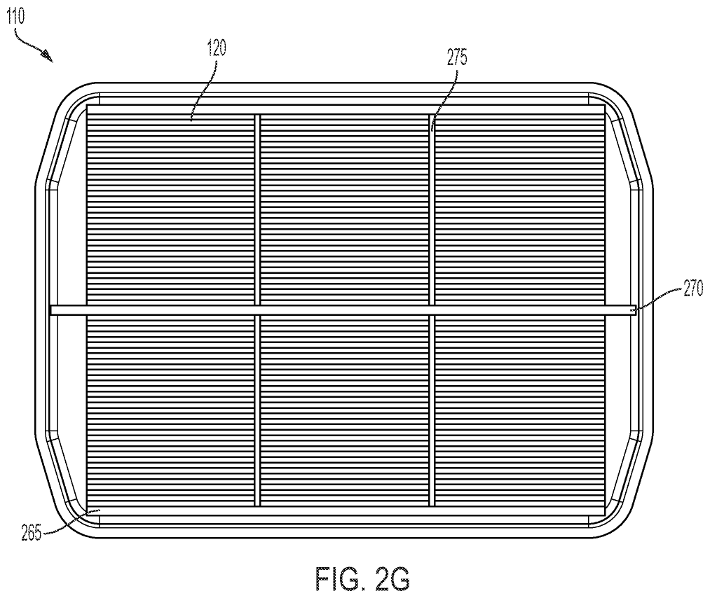

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The thermal components 215 shown adjacent to each other can be combined into a single thermal component 215 that spans the size of one or more submodules 220 or 225. The thermal component 215 can be positioned underneath submodule 220 and over submodule 225, in between submodules 220 and 225, on one or more sides of submodules 220, 225, among other possibilities. The thermal component 215 can be disposed in sidewalls, cross members, structural beams, among various other components of the battery pack, such as battery pack 110 described above. The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 220 and 225. The battery cells 120 can be disposed in the battery pack 110 in a cell-to-pack configuration without modules 220 and 225, among other possibilities.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A═Li, Ca, Sr, La, and B═Al, Ti), garnet-type with formula A₃B₂(XO₄)₃ (A═Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules (e.g., module-free). For example, as depicted in FIGS. 2F and 2G, the battery pack can have a module-free or cell-to-pack configuration where the battery cells 120 are arranged directly into a battery pack 110 without assembly into a module. In these embodiments, the battery pack 110 can include compression members 265 that facilitate managing swelling of the battery cells 120. A structural member 270 (e.g., cross beam) can also facilitate managing swelling of the battery cells 120. As depicted in FIG. 2G, the battery pack 110 can include one or more areas 275 for interconnections in which the cells 120 are joined together (e.g., electrically) using a busbar or welding.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg. Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also release lithium ions during the discharging of the battery cell 120. Conversely, the cathode layer 255 can receive electrical current into the battery cell 120 and can output electrons during the charging of the battery cell 120. The cathode layer 255 can receive lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M═Fe and/or Co and/or Mn and/or Ni)) chemistry, LISICON or NASICON Phosphates (Li₃M₂(PO₄)₃ and LIMPO₄Oₓ, M═Ti, V, Mn, Cr, and Zr), for example Lithium iron phosphate (LFP), Lithium iron manganese phosphate (LMFP), a layered oxides (LiMO₂, M═Ni and/or Co and/or Mn and/or Fc and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M═Fe, Co, Ni) and Fluorosulfates LiMSO₄F (M═Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylene diene monomer (EPDM) rubber, gelatine, gellan gum, guar gum, karaya gum, cellulose (natural), pectine, poly(3,4-cthylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A═Li, Ca, Sr, La, and B═Al, Ti), garnet-type with formula A₃B₂(XO₄)₃ (A═Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

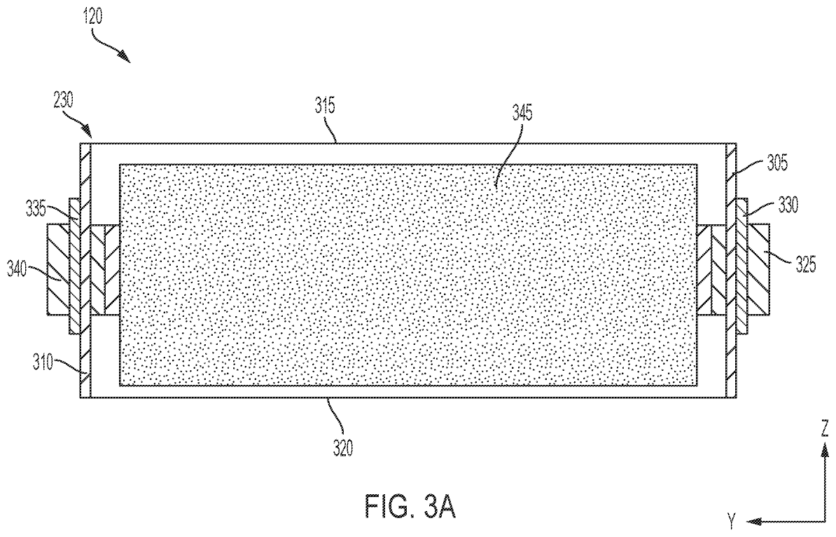

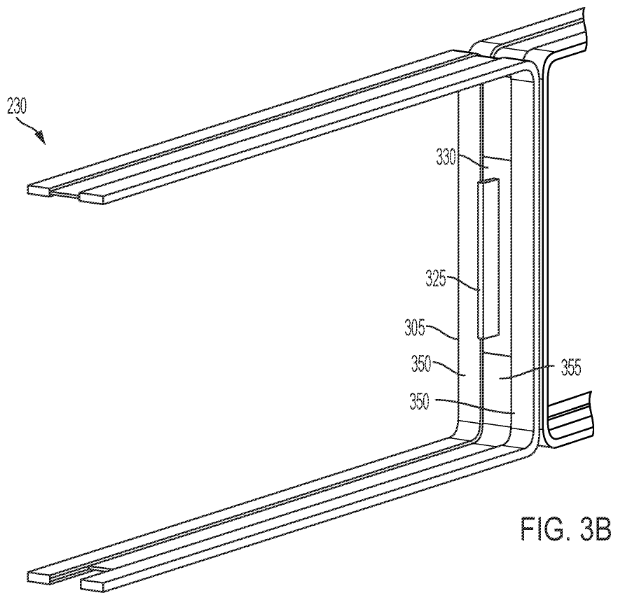

FIG. 3A depicts an example side view of a battery cell 120, according to implementations. As described herein, the battery cell 120 can include a battery cell housing 230. The housing 230 can be or can include one or more surfaces, walls, or other features that facilitate enclosing or surrounding an electrode 345 of the battery cell 120 (e.g., one or more electrodes that make up the jelly roll or stack). For example, at least a portion of the electrode 345 can be housed at least partially within or at least partially integrated with the housing 230 (e.g., an enclosure). The housing 230 can include at least one enclosure member 305. For example, the enclosure member 305 can correspond to a lid component, or a portion of a lid component. For example, the lid component can be a portion of an enclosure or a subset of an enclosure having a plurality of enclosure members 305. For example, enclosure members 305 can include one or more members of a structure corresponding to a can, a cap, a cap plate, a faceplate, a ring, a flexible polymer, or any portion or combination thereof. For example, enclosure members 305 can include one or more of a five-sided structure at least partially surrounding a cavity, a one-sided planar structure, and a tubular structure at least partially surrounding a cavity. An enclosure member 305 can be compatible with a cell-to-pack structural battery structure. An enclosure member 305 can be compatible with a battery module 115 battery structure. The battery cell housing 230 can at least partially enclose, surround, or form a pouch cell, a pris-pouch (e.g., a combination between prismatic and pouch), a prismatic cell, a cylindrical cell, or any combination thereof. For example, the battery cell housing 230 can include one or more rigid materials. The battery cell housing 230 can include one or more flexible materials (e.g., the enclosure member 305 can be a flexible polymer in a prismatic pouch form factor).

The battery cell housing 230 can include a first side (e.g., the enclosure member 305), a second side 310, a third side 315, a fourth side 320, a fifth side (extending between the third side 315 and fourth side 320) or a sixth side (opposing the fifth side). The enclosure member 305 can be or can include any one or more of the first side, the second side 310, the third side 315, the fourth side 320, the fifth side, or the sixth side. For example, the enclosure member 305 can be a portion of a can of a battery cell 120. The enclosure member 305 can at least partially surround or enclose at least one electrode 345. For example, the enclosure member 305 can be or can include a cap (e.g., cap plate), a faceplate, a ring, or any portion or combination thereof.

The battery cell 120 can include at least one terminal. For example, the battery cell 120 can include a first terminal 325 or a second terminal 340. The first terminal 325 can be identical and opposing the second terminal 340. The first terminal 325 can include a different configuration than the second terminal 340. The first terminal 325 and the second terminal 340 can position opposite one another. For example, if the first terminal 325 is coupled with the housing 230 at the first side (e.g., a first enclosure member 305), the second terminal 340 can be coupled with the housing 230 at the second side 310 (e.g., a second enclosure member) that opposes the first side. The first terminal 325 and the second terminal 340 can oppose one another by coupling with opposing enclosure members disposed on a side portion of the battery cell housing 230. Coupling the terminals on opposing sides of the battery cell housing 230 can facilitate providing a uniform electric field (e.g., in comparison to adjacent terminals or one terminal).

The first terminal 325 and the second terminal 340 can position adjacent to one another. For example, if the first terminal 325 is coupled with the housing 230 at the first side (e.g., the first enclosure member), the second terminal 340 can be coupled with the housing 230 at the third side 315 (e.g., another enclosure member) that is positioned adjacent the first side. The battery cell 120 can include a various amount of terminals (e.g., zero, one, two, or more).

The battery cell 120 can include at least one insert mold 330 (e.g., terminal mold) that can couple with the enclosure member 305 to couple the terminal 325 with the enclosure member 305. For example, the battery cell 120 can include a first insert mold 330 that can couple the first terminal 325 with the first side of the housing 230. The battery cell 120 can include a second insert mold 335 that can couple the second terminal 340 with the second enclosure member. The first insert mold 330 and the second insert mold 335 can be identical in configuration or the first insert mold 330 and the second inert mold 335 can include at least one difference. The insert mold 330 can be or can include one or more molded resins (e.g., plastic resins). The molded resin can include one or more additional materials integrally mixed with the resin, as described herein. The insert mold 330 can reduce or eliminate the need to bind a portion of the terminal 325, the enclosure member 305, and a current collector described herein. The insert mold 330 can be formed via various types of manufacturing processes including, but not limited to, injection molding, other types of molding, additive manufacturing, reductive manufacturing, or other various types of processes).

FIG. 3B depicts an example perspective view of a portion of a battery cell 120, according to implementations. For example, FIG. 3B depicts a portion of a battery cell housing 230. The battery cell housing 230 can include at least one portion having an “I” shape. For example, at least one portion of the enclosure member 305 can include an “I” beam cross section in which end portions 350 of the enclosure member 305 are thicker than a middle portion 355 of the enclosure member 305. The thickness of the “I” beam can vary. For example, the thickness between the topmost or bottommost end sections 350 as compared to the thickness in the middle section 355 can differ in the range of 10:1 to 10:9 (e.g., the thickness of the middle section 355 of the “I” beam can range between 10% thinner than the end sections 350 to 90% thinner than the end sections 350). The difference in thickness between the middle section 355 of the “I” beam and the end sections 355 can allow for the insert mold 330 to lie flush with one or more portions of the enclosure member 305 (e.g., with the end sections 350 as depicted in at least FIG. 3B).

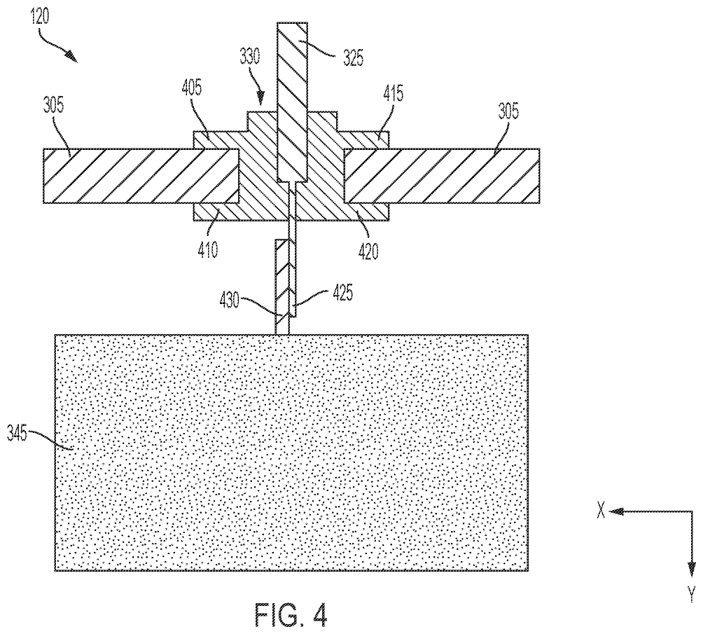

FIG. 4 depicts an example of the first terminal 325 coupled with the enclosure member 305 by the first insert mold 330. The insert mold 330 can include at least one portion that extends past, beyond, into, or adjacent to the enclosure member 305. For example, the insert mold 330 can include at least one flange (e.g., protrusion, extension, divot, overhang, arm, or another feature). The insert mold 330 can include at least one first flange 405, second flange 410, third flange 415, or fourth flange 420. The first flange 405 can position opposite the second flange 410 relative to the enclosure member 305. The first flange 405 can position opposite the third flange 415 relative to the terminal 325. The first flange 405, the second flange 410, the third flange 415, and the fourth flange 420 can each include the same configuration (e.g., length, width) or the first flange 405, the second flange 410, the third flange 415, and the fourth flange 420 can each differ in one or more ways.

The first flange 405 or the third flange 415 can position adjacent to a first side of the enclosure member 305 that opposes the electrode 345 and the second flange 410 or the fourth flange 420 can position adjacent to a second side of the enclosure member 305 that faces the electrode 345. The flanges can facilitate maintaining the position of the insert mold 330 relative to the enclosure member 305 (e.g., such that the insert mold 330 is fixed relative to the enclosure member 305 when the insert mold 330 is coupled with the enclosure member 305). The flanges can include a generally “C” or “U” shape (e.g., by the first flange 405 and the second flange 410, or by the third flange 415 and the fourth flange 420) to limit axial and rotational movement of the insert mold 330 relative to the enclosure member 305. The insert mold 330 can be molded to receive a portion of the terminal 325. For example, the insert mold 330 can include an aperture that partially receives or surrounds the terminal 325 such that the terminal 325 is fixed relative to the insert mold 330. The insert mold 330 can facilitate fixing the terminal 325 relative to the enclosure member 305 (e.g., rotationally or axially).

The terminal 325 can include or can couple with at least one current collector 425. The current collector 425 can include a metallic structure to transmit electrical current to or from the electrode 345 of the battery cell 120. The current collector 425 can be operatively coupled with or physically attached or integrated with the battery cell 120. The current collector 425 can have a planar or substantially planar structure that can couple with the terminal 325. The current collector 425 can be or can include a conductive material that can electrically couple the terminal 325 with another portion of the battery cell 120. For example, the current collector 425 can electrically couple one or more portions of the terminal 325 with a tab 430 (e.g., an uncoated region of a foil of the electrode 345) such that a conductive pathway is formed between the terminal 325 and the electrode 345 (e.g., electrical current can flow between the electrodes 345 of the electrode stack and the terminal 325). For example, a portion of the current collector 425 can be welded with a portion of the tab 430.

For example, each electrode 345 can include an active or coated region and an uncoated (e.g., inactive) region. The coated region can include an active material that is coated on a thin metallic surface (e.g., a metallic foil). For example, the coated region can include coating a foil formed of aluminum, copper, nickel, or another metallic material with an active material such as metal oxide, graphite, carbon black, carbon nanotubes, Super P carbon black material, Ketjen Black, Acetylene Black, SWCNT, MWCNT, graphite, carbon nanofiber, graphene, high-nickel content (>80% Ni) lithium transition metal oxide, a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”), or another active material. The uncoated region can be or can include regions of the electrode 345 that are uncoated (e.g., inactive) and can facilitate coupling the electrode 345 with the current collector 425. For example, the uncoated region can at least partially protrude from the electrode 345 (e.g., from the foil) to contact a portion of the current collector 425.

The uncoated region can be in electrical contact or a physical contact with the coated region. The uncoated region can provide, establish, or create an electrical contact or continuity between the coated region and the current collector 425. The electrode 345 can be or can include a notched (e.g., cut away, carved, etc.) foil or a foil without any notches. For example, the uncoated region can be notched to form the tab 430 of the electrode 345, in which case, the uncoated region can have a smaller dimension width than the coated region and can also be referred to as an electrode tab. In some examples, the uncoated region may not be notched in which the coated region and uncoated regions can have the same dimension. The current collector 425 can be formed of various types of aluminum, copper, nickel, or other metallic material.

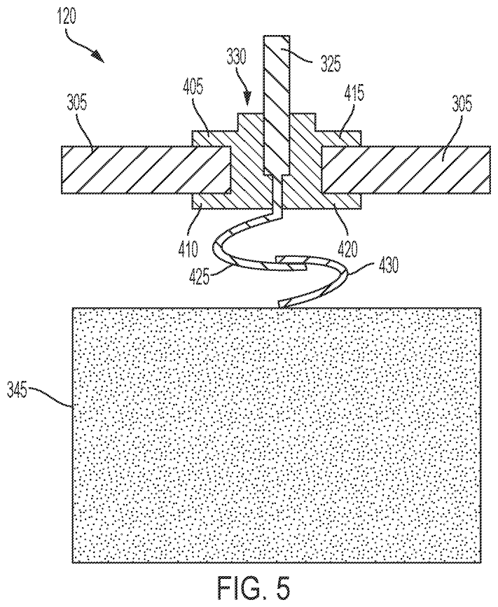

FIG. 5 depicts an example of a portion of the battery cell 120 in which the current collector 425 and the tab 430 are in a bent state. For example, the current collector 425 or the tab 430 of the electrode 345 can include one or more flexible materials such that at least one of the current collector 425 or the tab 430 of the electrode 345 can include a bend (e.g., to form a “U” shape, a “C” shape, a serpentine shape such as a “Z” shape or “S” shape, or another shape).

The flexible tab 430 or current collector 425 can facilitate increasing energy density within the battery cell 120. For example, the bending of the current collector 425 or the tab 430 can reduce the size of the tab 430 and the current collector 425 (e.g., in a direction that extends away from the terminal 325 and towards the electrode 345). The reduction in size can allow for more room for active (e.g., coated) material inside the battery cell housing 230, which can increase the energy density of the battery cell 120. For example, the length of the current collector 425 and the tab 430 welded together and fully extended can be about 10 mm. The length of the current collector 425 and the tab 430 welded together and bent can be about 5 mm. In other words, the bending of the tab 430 and the current collector 425 can increase the amount of active material in one direction by about 5 mm. This example is for illustrative purposes. The length of the current collector 425 and the tab 430 can significantly increase (e.g., more than 10 mm) or significantly decrease (e.g., less than 10 mm).

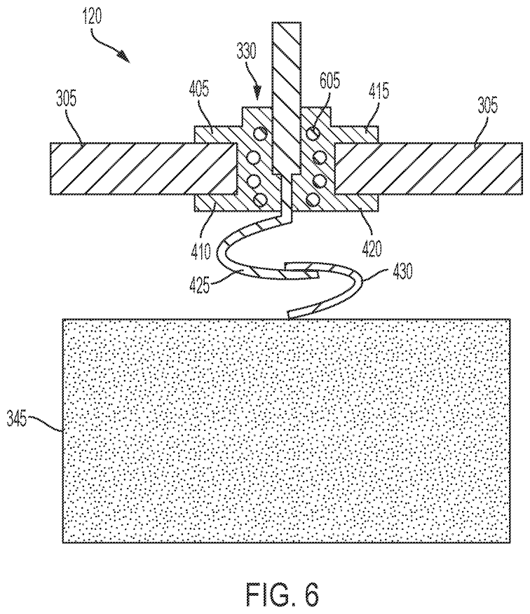

FIG. 6 depicts an example of a portion of the battery cell 120. As described herein, the insert mold 330 can be formed from a variety of materials. For example, the insert mold 330 can be formed of molded plastic resin. The insert mold 330 can include at least a portion of conductive material. For example, the insert mold 330 can include one or more carbon-based materials 605 embedded within the insert mold 330 (e.g., conductive carbon black, carbon nano tube, or carbon glass fiber. For example, at least a portion of the insert mold 330 can have an electrical resistance between 0 and 10,000 kΩ. For example, at least a portion of the insert mold 330 can have a lesser contact resistance in comparison to some conventional techniques. For example, the insert mold 330 can include about 10-30% carbon-based materials 605. These examples are for illustrative purposes. The insert mold 330 can include substantially more or less conductive materials or a higher or lesser electrical resistance.

The conductive material can facilitate balancing electrical resistance to prevent internal short circuiting between the terminal 325 and the electrode 345. The conductive material can facilitate preventing LiAl alloy generation, which can facilitate preventing corrosion inside the battery cell 120. For example, the electrical resistance can increase or decrease by loading of the conductive material. For example, the conductive material can facilitate the insert mold 330 being self-discharging. The addition of carbon material, such as carbon glass fibers, in the plastic resin of the insert mold 330 can facilitate enhancing mechanical strength and resistance to mechanical fatigue of the terminal 325. For example, strengthening the insert mold 330 with carbon glass fiber can reduce or eliminate stresses on the terminal 325 when the terminal 325 is coupled with the insert mold 330. The carbon-based materials 605 illustrated in FIG. 6 are for illustrative purposes. The carbon-based material integrated into the insert mold 330 may not be visible to the naked human eye.

The insert mold 330 can include at least one gasket embedded within the insert mold 330. For example, the insert mold 330 can include one or more sealing properties (e.g., one or more gaskets integrally formed within the insert mold 330) such that the need for additional gaskets is reduced or eliminated to seal the electrode 345 from outside of the enclosure.

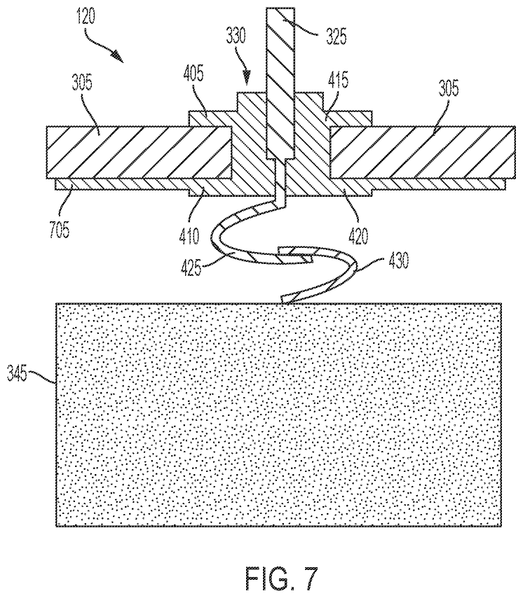

FIG. 7 depicts an example of a portion of the battery cell 120. The insert mold 330 can replace or eliminate a need for insulating materials within the battery cell housing 230, or the insert mold 330 can contact, couple with, or be disposed adjacent to one or more insulators. For example, an insulating material 705 can be disposed on the second side of the enclosure member that faces the electrode 345, as depicted in at least FIG. 7. For example, the insulating material 705 can be or can include one or more fibers (e.g., carbon fiber), polyurethane materials, resins, foams, composites, or other insulating materials. In some examples, the insert mold 330 can include one or more insulating materials molded or embedded within the insert mold 330 such that no additional insulating materials are necessary, as depicted in at least FIG. 6.

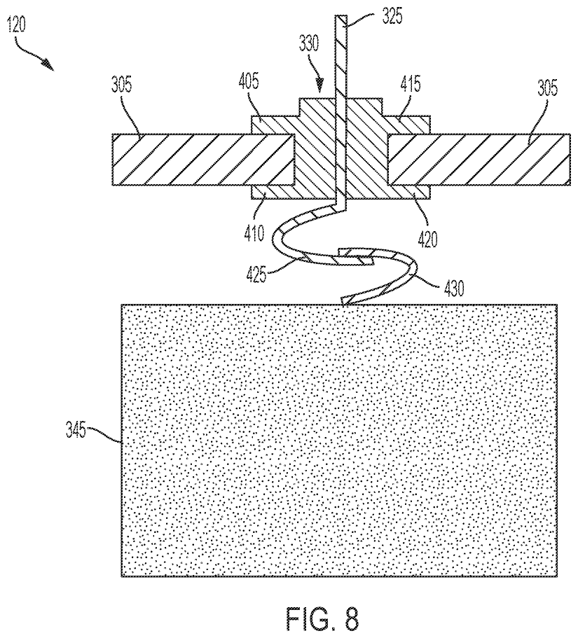

FIG. 8 depicts an example of a portion of the battery cell 120. As described herein, the battery cell 120 can be configured for various battery configurations (e.g., module or module-free). In some battery configurations, the terminal 325 and the current collector 425 can be coupled in various ways, or the current collector 425 can be monolithically formed with the current collector 425 such that the terminal 325 and the current collector 425 form one continuous structure, as depicted in at least FIG. 8.

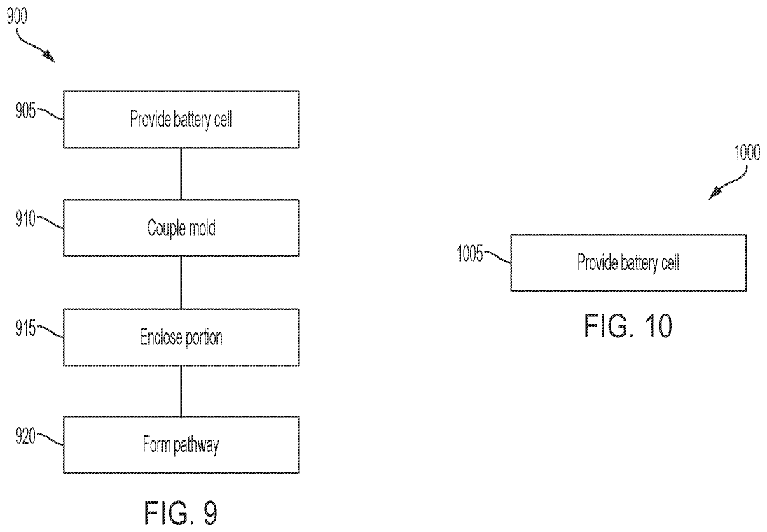

FIG. 9 depicts an example illustration of a method 900. The method 900 can include providing a battery cell 120, as depicted in act 905. For example, the battery cell 120 can include a prismatic battery cell, a pouch battery cell, a cylindrical battery cell, any combination thereof, or another type of battery cell. The battery cell 120 can include a battery cell housing 230. The housing 230 can include a plurality of sides (e.g., enclosure members 305) that enclose or surround an electrode of the battery cell 120 (e.g., the jelly roll or stack, the active electrolyte material). One or more sides of the battery cell housing 230 can include a portion of a can, a face plate, a cap plate, a portion of a ring, or another component. One or more sides of the battery cell housing 230 can include one or more apertures (e.g., holes, openings, channels, or another feature) including a fill port, a vent, or another feature.

The method 900 can include coupling the insert mold 330 with a portion of one or more of the enclosure members 305 (e.g., sides, surfaces, a portion of the can, a portion of a ring, a portion of a cap plate, a portion of a face plate, a lid, or another feature) of the battery cell housing 230, as depicted in act 910. For example, as described herein, the insert mold 330 can include one or more flanges. The flanges can facilitate coupling with the enclosure member 305 such that movement of the insert mold 330 is limited axially or rotationally relative to the enclosure member 305. The insert mold 330 can include a first flange 405, a second opposing flange 410, a third flange 415, and a fourth opposing flange 420. The method can include positioning one or more of the flanges adjacent to a first side of the enclosure member 305 (e.g., that faces the electrode 345, that is not exposed external to the battery cell housing 230). The method can include positioning one or more of the flanges adjacent to a second opposing side of the enclosure member 305 (e.g., that faces away from the electrode 345, that is exposed external to the battery cell housing 230). The insert mold 330 can be formed of one or more resins and one or more additional conductive materials (e.g., one or more carbon-based materials described herein).

The method 900 can include enclosing, by the insert mold 330, a portion of a terminal 325 of the battery cell 230, as depicted in act 915. For example, the insert mold 330 can at least partially surround at least a portion of the terminal 325. The insert mold 330 can enclose a portion of the terminal 325 before, after, or simultaneously with the insert mold 330 coupled with the enclosure member 305. For example, the terminal 325 can be molded with the insert mold 330. The terminal 325 can couple with the insert mold 330 after the insert mold 330 has been formed. The insert mold 330 can couple with the terminal 325 such that the terminal 325 is substantially rigidly fixed with the insert mold 330 (e.g., the terminal is axially or rotationally fixed relative to the insert mold 330). The insert mold 330 can facilitate fixing the terminal 325 relative to the enclosure member 305.

The method 900 can include forming a conductive pathway between the terminal 325 and the electrode 345 of the battery cell 120, as depicted in act 920. For example, the terminal 325 can include or can couple with a current collector 425. The current collector 425 can couple with (e.g., via welding) a tab 430 of the electrode 345. The terminal 325, the current collector 425, or the tab 430 can include one or more conductive materials such that electricity can flow to, from, or between the terminal 325, the current collector 425, and the tab 430 (e.g., to, from, or between the active material of the electrode 345).

At least one of the current collector 425 or the tab 430 can include one or more flexible materials or regions such that the current collector 425 or the tab 430 can bend. For example, as depicted in at least FIGS. 5-7, the current collector 425 and the tab 430 can bend to form a serpentine shape (e.g., an “S” shape, a “Z” shape, or another shape), or one of the current collector 425 or tab 430 can bend to form a “U” shape, a “C” shape, or another shape. The bending of the current collector 425 and the tab 430 can facilitate reducing space necessary in the battery cell housing 230 to accommodate the current collector 425 and the tab 430 than if the current collector 425 and the tab 430 were fully extended, as depicted in at least FIG. 4, among others.

The insert mold 330 can include an integrated gasket or seal. For example, the insert mold 330 can be formed with one or more sealing material such that the insert mold 330 seals the terminal 325 with the enclosure member 305 or seals the electrode 345 from being exposed to the external of the battery cell housing 230. For example, the insert mold 330 may reduce or eliminate the need for any additional sealing components within the battery cell housing 230. The insert mold 330 can include an integrated insulating material or the insert mold 330 can couple with (e.g., be positioned near) an insulating material 705. For example, the insulating material 705 can line an internal or external portion of the battery cell housing 230. In some examples, the battery cell housing 230 may not include any insulating materials 705 because the insert mold 330 includes an integrating insulating material.

The battery cell 120 can include a plurality of terminals that each couple with a respective enclosure member 305, or with the same enclosure member 305. For example, as depicted in at least FIG. 3A, the battery cell 120 can include two terminals 325, 340 that oppose one another on opposite sides (e.g., opposite enclosure members 305, 310) of the battery cell housing 230. Each terminal 325, 340 can couple with the enclosure member 305, 310 by a respective insert mold 330, 335. This example is for illustrative purposes. The battery cell 120 can include more or less terminals disposed on the same or different sides of the battery cell housing 230.

FIG. 10 depicts an example illustration of a method 1000. The method 1000 can include providing a battery cell 120, as depicted in act 1005. For example, the battery cell 120 can include a prismatic battery cell, a pouch battery cell, a cylindrical battery cell, any combination thereof, or another type of battery cell. The battery cell 120 can include a battery cell housing 230. The housing 230 can include a plurality of sides (e.g., enclosure members 305) that enclose or surround an electrode of the battery cell 120 (e.g., the jelly roll or stack, the active electrolyte material). One or more sides of the battery cell housing 230 can include a portion of a can, a face plate, a cap plate, a portion of a ring, or another component. One or more sides of the battery cell housing 230 can include one or more apertures (e.g., holes, openings, channels, or another feature) including a fill port, a vent, or another feature.

The battery cell 120 can include one or more insert molds 330 that couple with a portion of one or more of the enclosure members 305 (e.g., sides, surfaces, a portion of the can, a portion of a ring, a portion of a cap plate, a portion of a face plate, a lid, or another feature) of the battery cell housing 230. For example, the insert mold 330 can include one or more flanges. The flanges can facilitate coupling with the enclosure member 305 such that movement of the insert mold 330 is limited axially or rotationally relative to the enclosure member 305. The insert mold 330 can include a first flange 405, a second opposing flange 410, a third flange 415, and a fourth opposing flange 420. The method can include positioning one or more of the flanges adjacent to a first side of the enclosure member 305 (e.g., that faces the electrode 345, that is not exposed external to the battery cell housing 230). The method can include positioning one or more of the flanges adjacent to a second opposing side of the enclosure member 305 (e.g., that faces away from the electrode 345, that is exposed external to the battery cell housing 230). The insert mold 330 can be formed of one or more resins and one or more additional conductive materials (e.g., one or more carbon-based materials described herein).

The insert mold 330 can enclose a terminal 325 of the battery cell 120. For example, the insert mold 330 can surround at least a portion of the terminal 325. The insert mold 330 can enclose a portion of the terminal 325 before, after, or simultaneously with the insert mold 330 coupled with the enclosure member 305. For example, the terminal 325 can be molded with the insert mold 330. The terminal 325 can couple with the insert mold 330 after the insert mold 330 has been formed. The insert mold 330 can couple with the terminal 325 such that the terminal 325 is substantially rigidly fixed with the insert mold 330 (e.g., the terminal is axially or rotationally fixed relative to the insert mold 330). The insert mold 330 can facilitate fixing the terminal 325 relative to the enclosure member 305.

The terminal 325 and the electrode 345 of the battery cell 120 can electrically couple with one another. For example, the terminal 325 can include or can couple with a current collector 425. The current collector 425 can couple with (e.g., via welding) a tab 430 of the electrode 345. The terminal 325, the current collector 425, or the tab 430 can include one or more conductive materials such that electricity can flow to, from, or between the terminal 325, the current collector 425, and the tab 430 (e.g., to, from, or between the active material of the electrode 345).

At least one of the current collector 425 or the tab 430 can include one or more flexible materials or regions such that the current collector 425 or the tab 430 can bend. For example, as depicted in at least FIGS. 5-7, the current collector 425 and the tab 430 can bend to form a serpentine shape (e.g., an “S” shape, a “Z” shape, or another shape), or one of the current collector 425 or tab 430 can bend to form a “U” shape, a “C” shape, or another shape. The bending of the current collector 425 and the tab 430 can facilitate reducing space necessary in the battery cell housing 230 to accommodate the current collector 425 and the tab 430 than if the current collector 425 and the tab 430 were fully extended, as depicted in at least FIG. 4, among others.

The insert mold 330 can include an integrated gasket or seal. For example, the insert mold 330 can be formed with one or more sealing material such that the insert mold 330 seals the terminal 325 with the enclosure member 305 or seals the electrode 345 from being exposed to the external of the battery cell housing 230. For example, the insert mold 330 may reduce or eliminate the need for any additional sealing components within the battery cell housing 230. The insert mold 330 can include an integrated insulating material or the insert mold 330 can couple with (e.g., be positioned near) an insulating material 705. For example, the insulating material 705 can line an internal or external portion of the battery cell housing 230. In some examples, the battery cell housing 230 may not include any insulating materials 705 because the insert mold 330 includes an integrating insulating material.

The battery cell 120 can include a plurality of terminals that each couple with a respective enclosure member, or with the same enclosure member. For example, as depicted in at least FIG. 3A, the battery cell 120 can include two terminals 325, 340 that oppose one another on opposite sides (e.g., opposite enclosure members 305, 310) of the battery cell housing 230. Each terminal 325, 340 can couple with the enclosure member 305, 310 by a respective insert mold 330, 335.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure. For example, the battery cell can include a plurality of terminals disposed on various sides of the battery cell or the battery cell can include on terminal on one side of the battery cell.

Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A battery cell, comprising:
an enclosure member to enclose an electrode;
a unitary mold that couples with a portion of the enclosure member, the mold to at least partially surround a portion of a terminal, the mold including a flange positioned adjacent to a side of the enclosure member; and
the terminal to form a conductive pathway with the electrode.

2. The battery cell of claim 1, wherein the flange is a first flange, and the side of the enclosure member is a first side of the enclosure member, comprising:
the enclosure member including a second side;
the mold including a second flange; and
the second flange of the mold positioned adjacent to the second side of the enclosure member.

3. The battery cell of claim 1, comprising:
a current collector to electrically couple with a portion of the terminal;
the current collector to electrically couple with a portion of a tab of the electrode; and
at least one of the current collector or the tab includes a bend.

4. The battery cell of claim 1, comprising:
a housing that includes the enclosure member, a second opposing enclosure member, a first side, a second side, a third side, and a fourth side.

5. The battery cell of claim 1, comprising:
the mold comprises an integrated gasket to seal the mold with a portion of the enclosure member.

6. The battery cell of claim 1, comprising:
the enclosure member comprises a faceplate.

7. The battery cell of claim 1, comprising:
the mold comprises a plastic resin and at least one carbon material.

8. A method, comprising:
providing a battery cell having an enclosure member enclosing an electrode;
coupling a unitary mold with a portion of the enclosure member, the mold including a flange positioned adjacent to a side of the enclosure member;
enclosing, by the mold, a portion of a terminal; and
forming a conductive pathway between the terminal and the electrode.

9. The method of claim 8, wherein the flange is a first flange, and the side of the enclosure member is a first side of the enclosure member, comprising:
the enclosure member includes a second side;
the mold includes a second flange;
positioning the first flange of the mold adjacent to the first side of the enclosure member; and
positioning the second flange of the mold adjacent to the second side of the enclosure member.

10. The method of claim 8, comprising:
a current collector to electrically couple with a portion of the terminal;
the current collector to electrically couple with a portion of a tab of the electrode; and
at least one of the current collector or the tab includes a bend.

11. The method of claim 8, comprising:
a housing that includes the enclosure member, a second opposing enclosure member, a first side, a second side, a third side, and a fourth side.

12. The method of claim 8, comprising:
the mold comprises an integrated gasket to seal the mold with a portion of the enclosure member.

13. The method of claim 8, comprising:
the enclosure member comprises a can, a cap, a cap plate, a faceplate, a ring, a flexible polymer sheet, or a combination thereof.

14. The method of claim 8, comprising:
the mold comprises a plastic resin and at least one carbon material.

15. An electric vehicle, comprising:
a battery cell, comprising:
an enclosure member to enclose an electrode;
a unitary mold that couples with a portion of the enclosure member, the mold to surround a portion of a terminal, the mold including a flange positioned adjacent to a side of the enclosure member; and
the terminal to form a conductive pathway with the electrode.

16. The electric vehicle of claim 15, wherein the flange is a first flange, and the side of the enclosure member is a first side of the enclosure member, comprising:
the enclosure member including a second side;
the mold includes a second flange; and
the second flange of the mold positioned adjacent to the second side of the enclosure member.

17. The electric vehicle of claim 15, comprising:
a current collector to electrically couple with a portion of the terminal;
the current collector to electrically couple with a portion of a tab of the electrode; and
at least one of the current collector or the tab includes a bend.

18. The electric vehicle of claim 15, comprising:
a housing that includes the enclosure member, a second opposing enclosure member, a first side, a second side, a third side, and a fourth side.

19. The electric vehicle of claim 15, comprising:
the mold comprises an integrated gasket to seal the mold with a portion of the enclosure member.

20. The electric vehicle of claim 15, comprising:
the battery cell comprises one of a pouch battery cell or a prismatic battery cell.
